(19) United States
(12) Patent Application Publication
(10) Pub. No.: US 2026/0094159 A1
(43) Pub. Date: Apr. 2, 2026

(54) BIOMETRIC KERNEL, INTEROPERABILITY, AND PAYMENT AUTHENTICATION SYSTEMS

(71) Applicant: PopID, Inc., Diamond Bar, CA (US)

(72) Inventors: John Miller, Diamond Bar, CA (US); Sean Olson, Diamond Bar, CA (US); Ashish Gupta, Diamond Bar, CA (US); Seveda Abraamyan, Diamond Bar, CA (US); Henning Zieger, Diamond Bar, CA (US); Tom Costello, Diamond Bar, CA (US); Tony Lomelino, Diamond Bar, CA (US); Quan Lam, Diamond Bar, CA (US); Jared Levine, Diamond Bar, CA (US)

(21) Appl. No.: 19/311,246

(22) Filed: Aug. 27, 2025

Related U.S. Application Data
(63) Continuation-in-part of application No. 18/936,547, filed on Nov. 4, 2024.
(60) Provisional application No. 63/606,178, filed on Dec. 5, 2023.
(60) Provisional application No. 63/665,899, filed on Jun. 28, 2024.
(60) Provisional application No. 63/688,850, filed on Aug. 29, 2024.

(51) Int. Cl. G06Q 20/40; G06F 21/32; G06V 40/40; G06V 40/50

(52) U.S. Cl. CPC G06Q 20/40145; G06F 21/32; G06V 40/45; G06V 40/50

(57) ABSTRACT

A vendor agnostic biometric kernel provides preprocessing, canonical template generation, multi signal liveness aggregation, interoperability adapters, a secure template vault, and a policy engine that selects among matcher pipelines responsive to context. The kernel records user consent and emits signed audit logs. Portions of the kernel execute on an edge device while other portions execute in cloud services. The system outputs authentication assertions suitable for merchant payment authorization.

### CROSS-REFERENCE TO RELATED APPLICATIONS

The present application is a continuation in part of U.S. patent application Ser. No. 18/936,547, filed Nov. 4, 2024, entitled “METHODS AND APPARATUS FOR BIOMETRIC PAYMENT AUTHENTICATION,” the entirety of which is incorporated herein by reference.

The present application also claims the benefit under 35 U.S.C. § 119 (e) of the following U.S. Provisional Patent Applications, each incorporated herein by reference in its entirety: U.S. Provisional Application No. 63/709,822, filed Oct. 21, 2024, entitled “INTEROPERABILITY AND IMPROVED PERFORMANCE OF BIOMETRIC PAYMENT SYSTEMS”; U.S. Provisional Application No. 63/688,850, filed Aug. 29, 2024, entitled “INTEROPERABILITY AND IMPROVED PERFORMANCE OF BIOMETRIC PAYMENT SYSTEMS”; U.S. Provisional Application No. 63/716,329, filed Nov. 5, 2024, entitled “BIOMETRIC KERNEL”; U.S. Provisional Application No. 63/716,339, filed Nov. 5, 2024, entitled “INTELLIGENT HARDWARE AND SOFTWARE SYSTEMS FOR PREDICTING AND AFFIRMING CONSUMER SELECTION OF FACE OR PALM FOR BIOMETRIC TRANSACTIONS, PAYMENT, ACCESS CONTROL, AND LOYALTY PROGRAM CHECK IN AUTHENTICATION”; and U.S. Provisional Application No. 63/825,999, filed Jun. 17, 2025, entitled “ENHANCED MULTI MODAL DRIVE THRU AUTHENTICATION SYSTEM.”

### BACKGROUND OF THIS INVENTION

### Field

The present invention relates to biometric processing pipelines (a “kernel”), interoperability among heterogeneous biometric devices and formats, and secure authentication workflows for merchant payment transactions across edge and cloud components.

### Background

Automated online and retail payment systems, including those used for rewards, customer loyalty systems, and other systems associated with secure identification, are well known in the prior art. In retail settings these systems involve the use of some type of a point of sale (POS) terminal. The POS terminal can take many forms, from a stand-alone terminal connected to a cash register, a tablet computer running a POS application, a grocery store self checkout station, or terminals built into other devices like gas pumps, vending machines, ATMs, kiosks, drive thru applications, and other variations.

Each such system has the ability to read a credit/debit card either by swiping the card through a magnetic card reading strip, or through the use of a card chip reader. Further, POS systems are typically enabled with near field communication (NFC) technology, which can read a card that is in very close proximity to the terminal by interacting with the chip on the card. Further still, typically terminals can also interface using NFC technology to communicate with a payment application running on a smart phone. This allows a user to pay using their phone as a proxy for the credit card, by holding the phone near the POS terminal.

Online systems often require manual entry of credit card and other authentication information, but computing devices (especially mobile devices) can be equipped with card reading modules that allow for automatically entering credit card information in a manner similar to what is described above in reference to retail systems.

Once the payment information is entered in the POS system, payment processing proceeds in a manner well known in the art.

Prior art POS systems of the type describe above suffer from a number of drawbacks. First, the system generally requires the user to present their card at the time of purchase. This creates an opportunity for the card to be lost, misplaced, stolen, or otherwise compromised. Credit card fraud is a huge problem, which is only exacerbated by requiring card holders to carry their cards on their person and present them to the POS system at the time of purchase.

Further, user not only have to carry their cards on them they have to remove the card from their purse or wallets, and then return them thereto after payment. This is a cumbersome process at best, especially in a retail setting where the user may have their hands full of merchandise or other items.

Also, if for some reason the user has forgotten or misplaced their card, the purchase cannot be completed.

Mobile payment systems, which relay on an application running on a smart phone and NFC technology to transmit the card information to the POS system, suffer from the same drawbacks. These systems do not require the physical presence of the card, but they do require the user have their phone with them and require that they open the phone or otherwise manually enable the payment application which is similarly cumbersome, and creates risk that the phone can be lost, stolen, or compromised.

A further problem comprises the fact that payment and transactions systems vary widely in size, shape, and platform/system requirements. Even those that can perform some limited biometric processing are typically incompatible with each other. A drawback of these systems is that to upgrade to better identification systems requires replacing equipment, and even then, each system only talks to itself making deploying a cross-platform identification software and hardware solution heretofore impossible.

Additionally, retail and payment deployments frequently mix capture devices and algorithms from multiple vendors. These heterogeneous systems often implement incompatible template formats, scoring ranges, and liveness detection approaches, which impedes reuse of enrollments, migration between vendors, and consistent security controls in production. Existing stacks also lack a principled way to route authentication to different matchers or policies based on risk, jurisdictions, device capability, or the transaction channel (in store, kiosk, drive thru).

There is a need for biometric identification systems to use a vendor agnostic biometric kernel that: (i) normalizes capture and quality; (ii) generates canonical templates; (iii) aggregates multi signal liveness; (iv) provides interoperability adapters to translate to and from vendor specific templates; (v) applies risk based policy to select matcher pipelines; and (vi) records consent and immutable audit data.

### SUMMARY OF THE INVENTION

In some embodiments, a vendor agnostic biometric kernel normalizes inputs from multiple modalities (e.g., face and palm), performs preprocessing and embedding generation to produce canonical templates, aggregates liveness signals, and stores templates in a secure vault with encryption, access control, and key rotation. Interoperability adapters translate vendor specific templates to canonical templates and back to vendor formats, enabling cross vendor enrollment reuse and migration. A policy engine selects among multiple matcher pipelines responsive to an authentication context comprising one or more of: channel, jurisdiction, device capability, network quality, enrollment tier, and measured risk. A consent manager records user consent at enrollment and prior to authentication where required, and an audit subsystem produces signed, tamper evident records of security relevant events. At least a portion of the kernel executes on an edge device (e.g., a POS connected module), while other portions execute in cloud services, enabling low latency matching with centralized policy and vault controls.

### BRIEF DESCRIPTION OF THE DRAWINGS

FIG. 1 is a block diagram of the biometric kernel including capture, quality, preprocessing, embedding, liveness aggregation, vault, fusion, policy engine, consent manager, and audit subsystems.

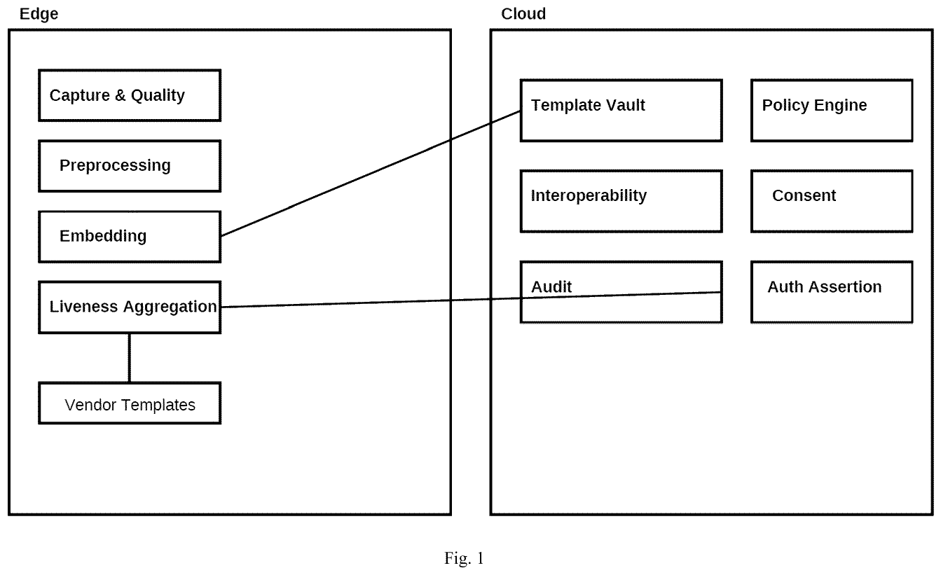

FIG. 2 is a system diagram of an interoperability hub with adapters linking heterogeneous devices to a canonical template vault and matcher selection service.

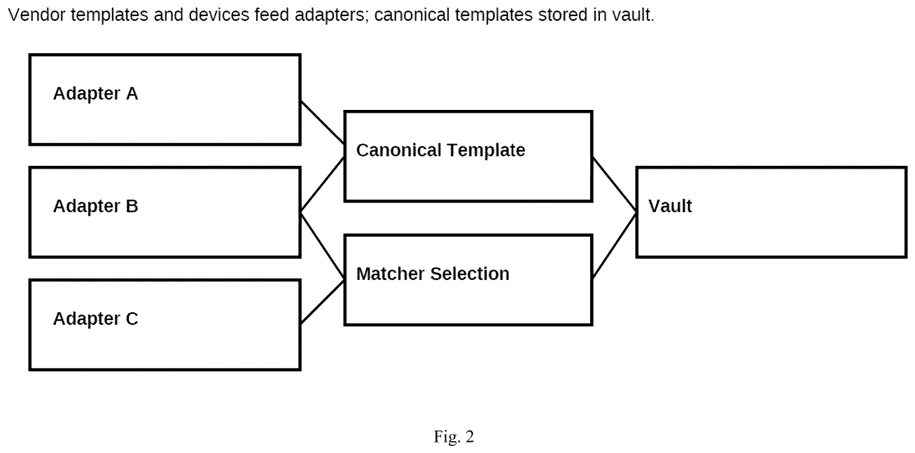

FIG. 3 illustrates a payment authentication flow at a merchant point of sale using the kernel with edge/cloud partitioning.

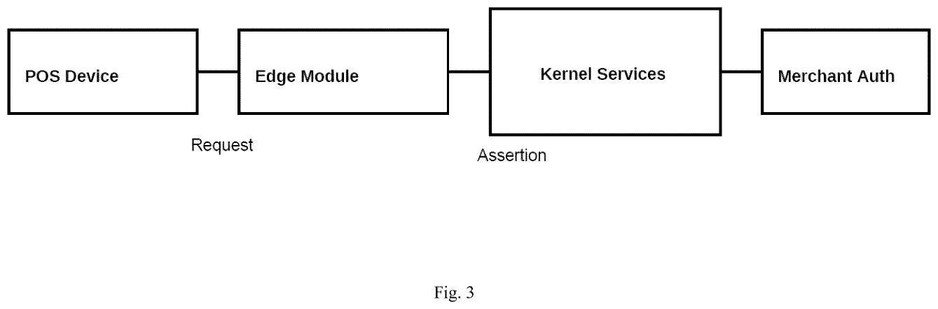

FIG. 4 illustrates enrollment normalization and de duplication across face and palm modalities.

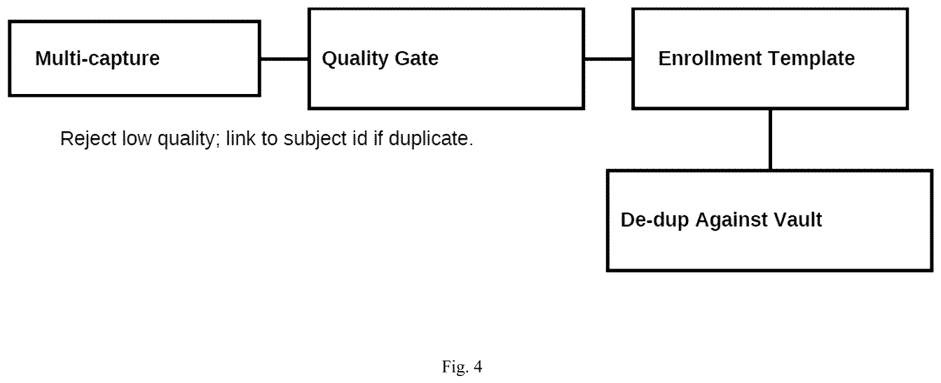

FIG. 5 depicts a liveness aggregation framework combining passive texture checks, photometric consistency, and challenge response.

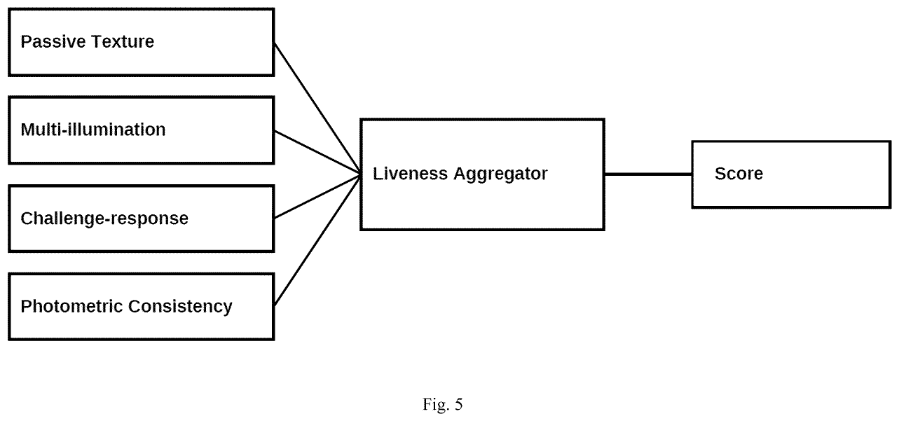

FIG. 6 depicts canonical template generation and versioning with backward compatibility.

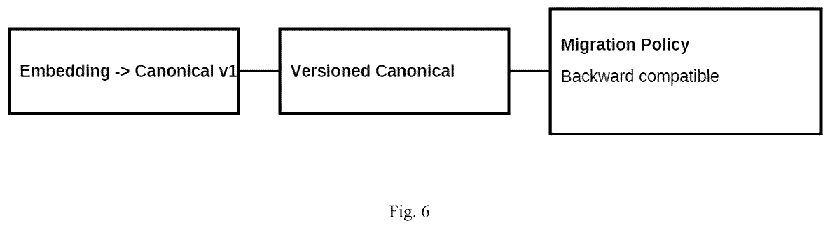

FIG. 7 shows an interoperability adapter translating vendor templates to canonical embeddings and back translation for legacy devices.

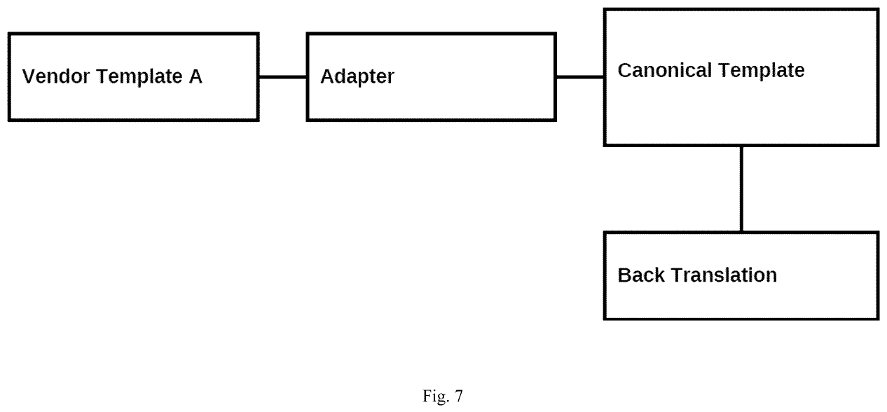

FIG. 8 shows policy based selection among multiple matcher pipelines for different contexts (kiosk, attended POS, drive thru).

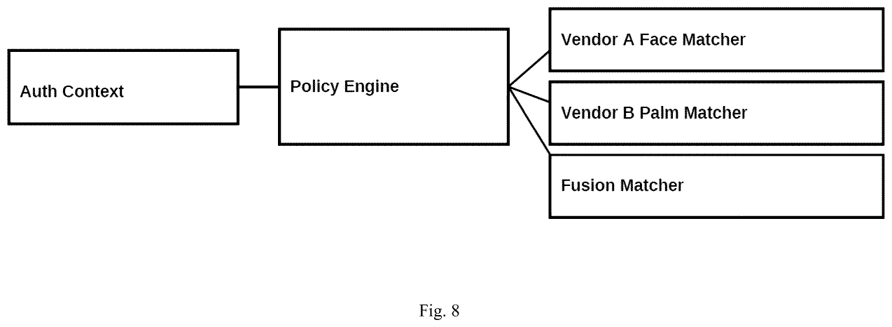

FIG. 9 shows a consent capture UI and signed audit record generation.

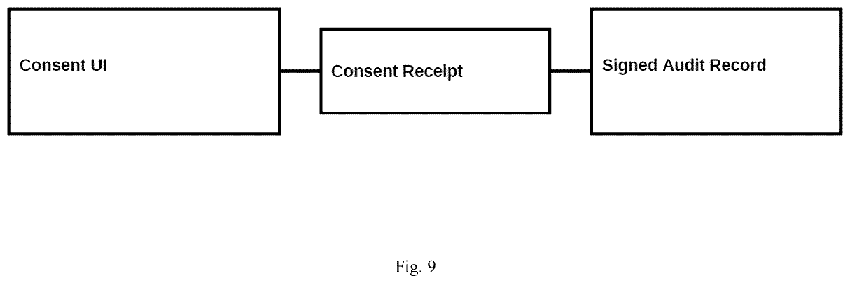

FIG. 10 shows a secure template vault with encryption, access control, and key rotation.

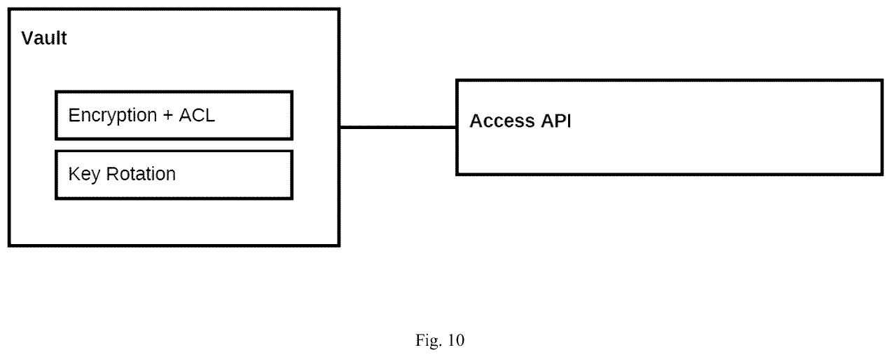

FIG. 11 shows edge-cloud deployment options and failover modes.

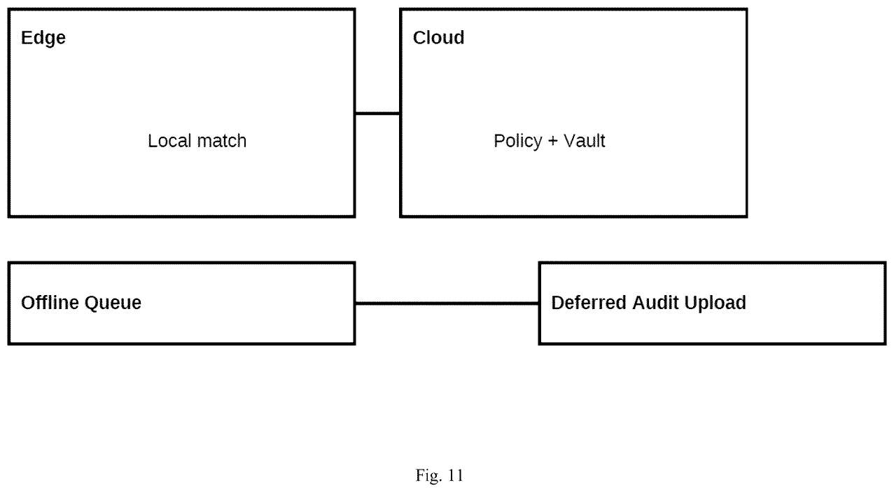

FIG. 12 shows a quality gate and dynamic capture control loop (exposure, illumination).

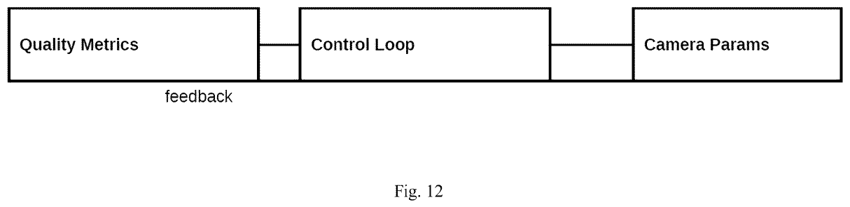

FIG. 13 shows multi modal fusion of face and palm match scores with learned weighting.

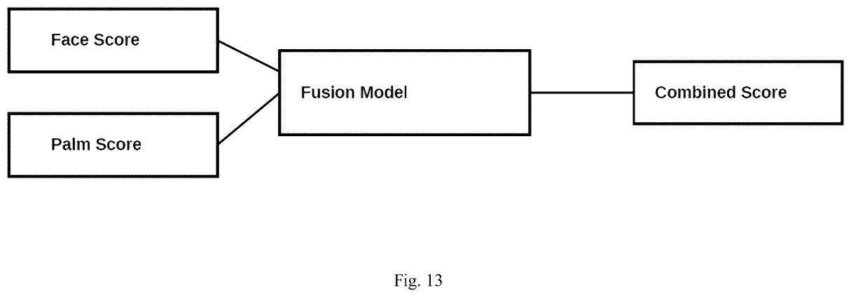

FIG. 14 shows privacy preserving tokenization of biometric identities for merchant integration.

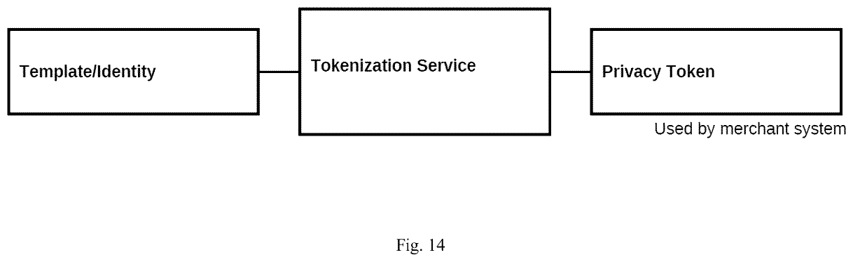

FIG. 15 shows a watchlist/blacklist enforcement pipeline blocking suspected fraud.

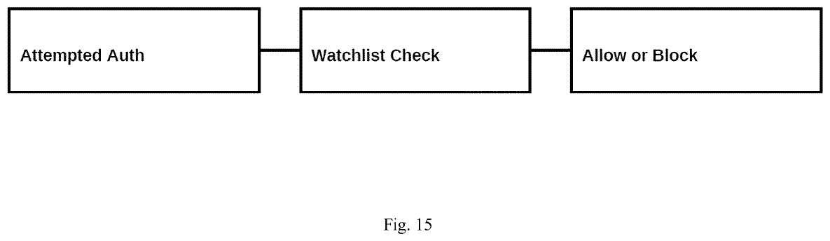

FIG. 16 shows a network degraded fallback with deferred audit upload.

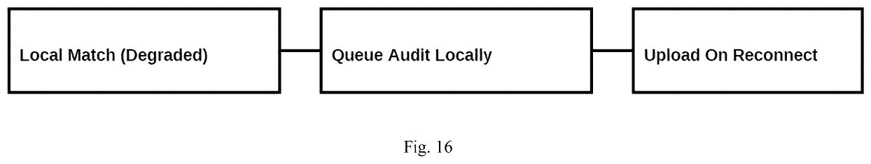

FIG. 17 shows an administrative console for policy configuration and algorithm selection.

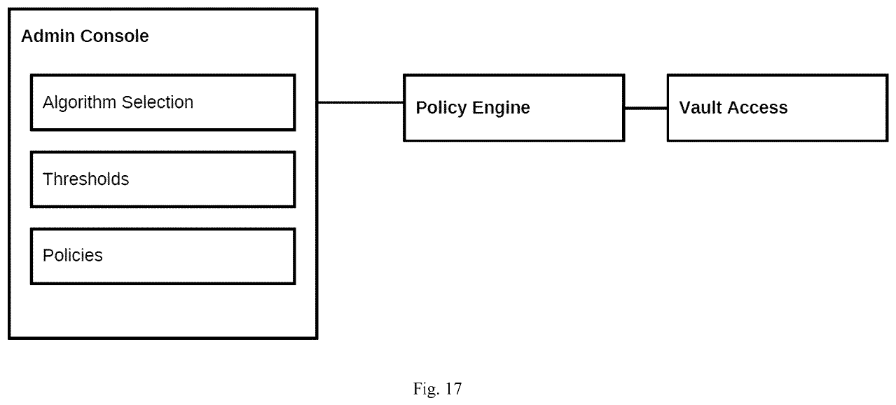

FIG. 18 shows data structures for templates, liveness vectors, consent receipts, and audit logs.

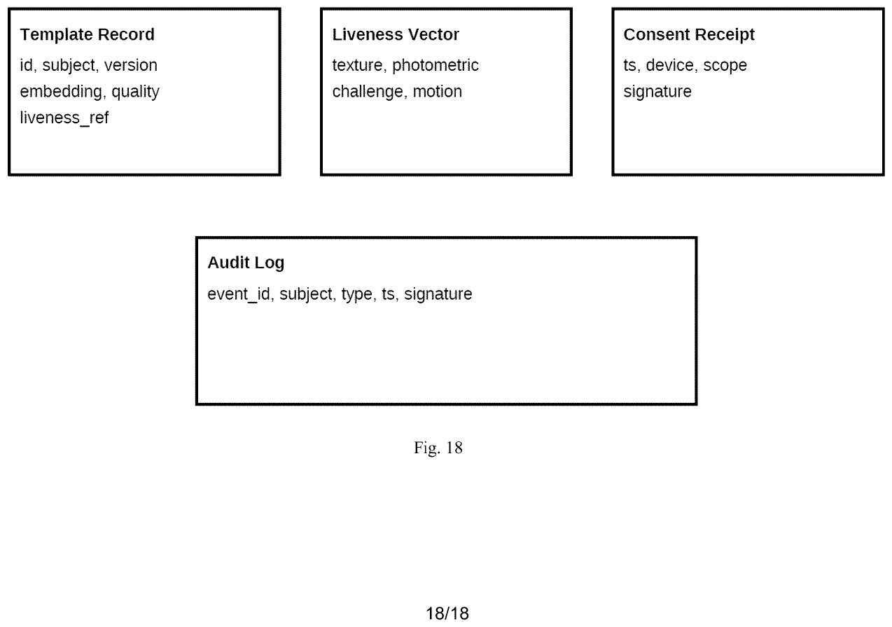

### DETAILED DESCRIPTION OF THE INVENTION

The present invention comprises a software kernel operating in a mixed computing environment specifically adapted for use with biometric identification systems that can operate on multiple systems and platforms all having different vendor and system processing requirements that are otherwise incompatible with each other.

The kernel of the present invention is deployed across one or more devices operating in a biometric identification system, where the general architecture of the system comprises the following components and functions:
A software based, preferably SaaS based, registration system for a user to register a facial image (or set of images). The user establishes an account, with a username and password (along with any other suitable authenticating information). The user than provides the aforementioned authenticating image(s), which will be used by the system to authenticate purchases or conduct any other activities described or referenced herein.
The system uses software to obtain a biometric vector from the registration image, hereafter the registration vector.
The user's mobile phone for interfacing with the registration system, including providing an authenticating image, which can be taken with the phones camera.
The user's payment credentials and method, which will be associated with the biometric account they create or have created with the BAPS.
A retailer's terminal or an ordering terminal, register, or kiosk for carrying out payment processing—the POS system/device.
A biometric module for interfacing with the retailer's POS system, such module either built into or attached to the POS system, wherein the module is equipped with a device for capturing biometric information consistent with the BAPS requirements.
A transaction image (or set of images) taken by the biometric module when the user wishes to use the BAPS for a transaction.
A biometric vector obtained from the transaction image, hereafter the transaction vector.
A cloud- or edge-based software system interfacing with the biometric module and the registration system for processing the transaction and authentications image for a match.

The present invention can be deployed in many operating environments, and across many different biometric systems all having its own protocols, templates, and the like. The present inventions can be applied to multiple types of biometric authentication included facial recognition, palm based identification systems, in person identification systems, cloud based systems (with or without live user presence data), or mixed systems that combined edge and cloud services. The present invention can be used with any type of system that utilizes biometric identification, including payment systems, customer loyalty systems, security systems, and the like.

In the case where the biometric identification information comprises images of the user's face the following procedures are employed. A user registers for a biometric account by providing authenticating information. Once the account is verified the user is provides their biometric information (an facial image or palm print for example).

The biometric information is analyzed with one anti-spoofing algorithms in a liveness check. Liveness for biometric identification is a critical security technology that verifies a user is a real, live person and not a fake representation, such as a photograph, 3-d image, mask, or video fake. If the image passes the test, then personal and biometric information is validated and the account is established and the user's biometric data is transformed into a biometric vector (the registration vector) using a facial recognition algorithm or the like.

When a user identify is validated by a biometric authentication modules associated with a one of the foregoing systems a live image of the user is captured and a liveness check is performed. Once the user has been confirmed to be a live individual, the user's image is processed as noted above to create a transaction vector, which is then compared to the registration vectors in a database to find a match. If a match is found the user is allowed to proceed with whatever transaction is subject to the authentication process, otherwise user access is denied.

As noted, different systems all use different specific variations on the above steps, and other steps, and some of these operations are configurable by vendors such that even the same systems used by different vendors operate in different manners. This results in a wider variety of generally incompatible processes, data, templates, and system.

The present invention provides a kernel operating on the above systems that standardizes the operations across systems and vendors. An overview of the kernel is provided below, with additional information provided following the overview.

Definitions and Overview. As used herein, a “template” refers to a compact representation derived from biometric input. The biometric template can represent data in a variety of ways including as an embedding vector that represents the underlying biometric data as an n-dimensional array capturing the features of the input data, as a minutiae set which is a set of local discontinuities in a pattern (such a palm print, facial image or even a fingerprint), or a learned feature map which is the output produced by applying a convolutional filter to the input data. A “canonical template” refers to a normalized representation produced by the kernel that supports stable thresholds and fusion across devices and vendors. An “interoperability adapter” converts between vendor specific template formats and the canonical template format, and back again.

Kernel Architecture. The kernel comprises an system level set of instructions executing on a device such as one used for biometric identification device or system such as a personal computer, local server, tablet, or a standalone device integrated into or with a point of sale or merchant or security system. The kernel includes the following functional modules: (i) a capture and quality subsystem controlling exposure, gain, and illumination of an image capture device associated with the system; (ii) a preprocessing pipeline performing detection, alignment, normalization, and artifact removal associated with a biometric identification algorithm; (iii) an embedding generator producing canonical templates; (iv) a liveness aggregation framework combining multiple presentation attack detection (PAD) signals which comprises various methods and technologies to combat sophisticated spoofing attempts against biometric authentication systems, such as faces, palm prints, fingerprints, and irises; (v) a template vault; (vi) a policy engine which is an administrative component of a biometric system that sets out the rules and conditions of a vendor's authentication criteria and protocols; (vii) a consent manager which is a platform that obtains, records, and manages users' explicit permission to collect and use their biometric data for example to ensure compliance with privacy laws, user preferences, and the like; and (viii) an audit subsystem. The kernel also comprises various APIs for enrollment, verification, and template migration.

Enrollment. During enrollment, the kernel performs multi capture acquisition using the associated biometric identification device, by employing techniques and control protocols such as quality gating, rejects low quality frames, and generates an enrollment template per modality. Duplicates are detected and screened by matching the newly created canonical template against existing entries; confirmed duplicates may link to the same subject identifier to prevent collisions such as when the system incorrectly matches a user's biometric sample to a different stored template, leading to an incorrect match (false positive) or when a user is unable to gain access due to the system failing to recognize their sample. User consent is captured and bound to the enrollment record with a digital signature.

Verification and Policy Routing. During verification, the kernel receives a probe input and its authentication context (e.g., POS vs. kiosk; drive thru; region; risk score). The policy engine selects a matcher pipeline and thresholding parameters. The matcher pipeline comprises a series of processing steps and algorithms involved in accurately comparing captured biometric data with a database of stored biometric information to identify an individual, such as vendor A face matcher, vendor B palm matcher, or a kernel native matcher profile, or a fusion matcher which combines various methods. Results and liveness scores are fused to produce an authentication assertion suitable for a authorization service such as a merchant or security service and the like.

Liveness Aggregation. The framework accepts passive texture analysis, photometric consistency across multi illumination frames, glare analysis, frequency domain artifacts, and optional challenge response signals. Signals are normalized and combined via learned or rules based weighting to produce a liveness score used for auditing, and providing the gatekeeping function referenced above.

Interoperability and Template Migration. Adapters translate vendor templates to canonical templates and back for backward compatibility. The system supports versioned canonical templates and migration policies for stable operations across algorithm updates. Vendor agnostic scoring ranges enable consistent thresholds for field operations.

Template Vault and Privacy. Templates and associated metadata are stored with encryption, access control, and key rotation. Privacy preserving tokens can be issued for merchant systems in place of raw templates or identifiers. Audit logs store signed records of consent, enrollment, verification attempts, and administrative actions.

Edge-Cloud Partitioning. Low latency capture, preprocessing, and liveness may execute at an edge module connected to a payment terminal; canonical template storage, policy management, and cross tenant analytics may execute in cloud services. Failover modes allow degraded operation during network loss with deferred audit upload. Edge-cloud partitioning is a computing paradigm where computationally intensive tasks or AI models are divided, or “partitioned,” between resource-constrained edge devices (such as the biometric identification devices) and more powerful cloud servers, creating an edge-cloud collaboration system. This approach optimizes performance by running computationally lighter parts of a process on the edge for low latency and offloading heavier computations to the cloud for greater processing power, enhancing overall speed, efficiency, and resource utilization.

Drive Thru and Kiosk Contexts. The kernel supports contexts such as indoor POS, kiosks, and drive thru configurations by adjusting capture profiles and policy routing; however, mechanical mounting and long range optics are handled in separate applications.

Implementation Considerations. Software components may be implemented using processors, GPUs, and specialized accelerators. Instructions are stored on non transitory computer readable media and executed by hardware to perform the disclosed methods.

Additionally, system has the ability to migrating user data and/or biometric information from one systems or protocol to another for enrollment or other purposes, by translating a vendor specific template to a canonical template and versioning the canonical template.

Further, the system includes a liveness aggregation framework that combines passive texture analysis such as analysis of fine-grained details and micro-texture patterns on the skin's surface, photometric consistency across multi illumination frames to ensure that appearance of and object a face (including a 3D rendering thereof) remains consistent by viewing different images captured or under varying lighting conditions, and challenge response signals representing the response of a live person learned weighting algorithms.

The system can also include quality gating to screen biometric input by rejecting frames that fail one or more criteria such as sharpness, exposure, or occlusion thresholds and adaptively controlling capture parameters associated with variations in biometric data.

The system can include recording user consent such as a signed consent receipt and binding that consent to at least one of the enrollment templates and an associated verification event.

The system can use the template vault to enforce tenant level access controls and emit privacy preserving tokens to merchant systems in lieu of raw identifiers which could be used to identity a person, including for the purpose of complying with privacy law, policies, or guidelines.

The system can use an interoperability adapter to support back translation of a canonical template to a vendor specific template to maintain compatibility with legacy devices.

The system can use multi modal fusion to combine face and palm (and other biometric data) match scores using a learned fusion model to enhance the accuracy of identification.

The system can include a blacklist enforcement pipeline configured to block authentication for subjects associated with suspected fraud or otherwise subject to systems restrictions.

The system can use the audit subsystem to store tamper evident records using cryptographic signatures and sequential counters.

The system can also operate in a network degraded mode that performs local matching and defers audit upload until connectivity is restored.

The system can use an edge device such as point of sale connected biometric module including an imaging sensor and an embedded processor.

The system of claim 1, wherein the policy engine adjusts a decision threshold responsive to the liveness score and the risk score.

The system can translate between formats by mapping between at least two vendor specific template schemas and the canonical template schema.

The system can version the canonical template and associated metadata to preserve backward compatibility across algorithm updates.

The present invention solves, or substantially solves the problem in the prior art by providing a biometric identification systems that uses a vendor agnostic biometric kernel that: (i) normalizes capture and quality; (ii) generates canonical templates; (iii) aggregates multi signal liveness; (iv) provides interoperability adapters to translate to and from vendor specific templates; (v) applies risk based policy to select matcher pipelines; and (vi) records consent and immutable audit data. Thereby allowing use of a single biometric kernel that is compatible with and can accommodate a wide variety of systems and vendor configurations, without the need for extensive changes thereto.

It is understood that the present subject matter may be embodied in many different forms and should not be construed as being limited to the embodiments set forth herein. Rather, these embodiments are provided so that this subject matter will be thorough and complete and will convey the disclosure to those skilled in the art. Indeed, the subject matter is intended to cover alternatives, modifications, and equivalents of these embodiments, which are included within the scope and spirit of the subject matter as defined by the appended claims and their equivalents. Furthermore, in the detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure may be described herein with reference to flowchart illustrations and/or block diagrams of methods, apparatuses (systems), and computer program products according to embodiments of the disclosure. It will be understood that some blocks of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

References to computer-readable media generally includes all types of computer-readable media, including magnetic storage media, optical storage media, and solid-state storage media. It should be understood that any software may be installed in and sold with the device. Alternatively, the software may be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) can be accessed by a computing device and/or processor(s), and include volatile and non-volatile internal and/or external media that is removable and/or non-removable. For computing devices, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in any appended claims is not necessarily limited to the specific features or acts described above. Rather, the specific features and acts described above are disclosed as example forms of implementing any claims.

What is claimed is:

1. A biometric processing system executing on the computer device through programmatic instructions comprising:
i) an input interface configured to receive biometric input from multiple capture devices and modalities including face and palm, and to receive vendor specific biometric templates;
ii) a preprocessing pipeline configured to perform at least detection, alignment, normalization, and artifact removal to produce quality normalized data;
iii) an embedding generator configured to produce canonical templates from the quality normalized data;
iv) a liveness aggregation framework configured to combine multiple presentation attack detection signals to produce a liveness score;
v) a template vault configured to store canonical templates and metadata using encryption, access control, and key rotation;
vi) an interoperability adapter configured to translate vendor specific template formats to the canonical templates and to translate the canonical templates back to vendor specific formats for backward compatibility;
vii) a policy engine configured to select, responsive to an authentication context, among a plurality of matcher pipelines and thresholding parameters;
viii) a consent manager configured to record user consent associated with enrollment and authentication events; an audit subsystem configured to produce signed records of said events; and a communications interface configured to output an authentication assertion for a merchant payment authorization service;
ix) wherein at least a portion of the preprocessing pipeline and liveness aggregation framework executes at an edge device and at least a portion of the template vault and policy engine executes in a cloud service.

2. A computer implemented method executing on the computer device through programmatic instructions comprising:
i) receiving, at a biometric kernel, biometric input from multiple capture devices and modalities;
ii) performing preprocessing comprising detection, alignment, normalization, and artifact removal;
iii) generating a canonical template from the preprocessed input;
iv) obtaining a liveness score by aggregating a plurality of presentation attack detection signals;
v) storing the canonical template in a template vault under encryption with access control and key rotation; selecting, responsive to an authentication context, a matcher pipeline and thresholding parameters using a policy engine;
vi) matching the canonical template against an enrollment template to produce an authentication result; recording user consent and generating a signed audit record; and outputting an authentication assertion for processing a merchant payment transaction.

3. A non transitory computer readable medium storing instructions that, when executed by one or more processors, cause the processors to:
i) receive biometric input from multiple modalities;
ii) perform preprocessing to generate normalized data;
iii) generate a canonical template;
iv) aggregate a plurality of liveness signals;
v) store the canonical template in a template vault with encryption and key rotation; translate between vendor specific template formats and the canonical template using an interoperability adapter;
vi) select a matcher pipeline responsive to an authentication context using a policy engine; match the canonical template to an enrollment template to obtain an authentication result; record consent and generate a signed audit record; and
vii) transmit an authentication assertion for a merchant payment authorization.

4. The system of claim 1, wherein the liveness aggregation framework combines passive texture analysis, photometric consistency across multi illumination frames, and challenge response signals using learned weighting.

5. The system of claim 1, wherein the input interface is further configured to receive pre existing vendor specific templates and to translate the templates into the canonical template for reuse.

6. The system of claim 1, wherein the policy engine selects among matcher pipelines comprising at least a kernel native matcher, a vendor A matcher, a vendor B matcher, and a fusion matcher.

7. The system of claim 1, wherein the authentication context comprises at least one of: transaction channel, device capability, jurisdiction, enrollment tier, network condition, and risk score.

8. The method of claim 2, further comprising migrating an enrollment by translating a vendor specific template to a canonical template and versioning the canonical template.

9. The method of claim 2, further comprising performing quality gating that rejects frames failing sharpness, exposure, or occlusion thresholds and adaptively controlling capture parameters.

10. The method of claim 2, wherein recording user consent comprises binding a signed consent receipt to at least one of the enrollment template and the verification event.

11. The system of claim 1, wherein the template vault enforces tenant level access controls and emits privacy preserving tokens to merchant systems in lieu of raw identifiers.

12. The system of claim 1, wherein the interoperability adapter supports back translation of a canonical template to a vendor specific template to maintain compatibility with legacy devices.

13. The system of claim 1, wherein multi modal fusion combines face and palm match scores using a learned fusion model.

14. The system of claim 1, further comprising a blacklist enforcement pipeline configured to block authentication for subjects associated with suspected fraud.

15. The system of claim 1, wherein the audit subsystem stores tamper evident records using cryptographic signatures and sequential counters.

16. The method of claim 2, further comprising operating in a network degraded mode that performs local matching and defers audit upload until connectivity is restored.

17. The system of claim 1, wherein the edge device comprises a point of sale connected biometric module including an imaging sensor and an embedded processor.

18. The system of claim 1, wherein the policy engine adjusts a decision threshold responsive to the liveness score and the risk score.

19. The non transitory computer readable medium of claim 3, wherein translating between formats comprises mapping between at least two vendor specific template schemas and the canonical template schema.

20. The system of claim 1, wherein the canonical template and associated metadata are versioned to preserve backward compatibility across algorithm updates.
